(19) United States
(12) Patent Application Publication
(10) Pub. No.: US 2008/0293886 A1
(43) Pub. Date: Nov. 27, 2008

(54) Use Of Amphiphilic Block Copolymers For Producing Polymer Blends

(75) Inventors: Ulrich Karl, Grunstadt (DE); Claudia Sierakowski, Seeheim-Jugenheim (DE); Mijolovic Darijo, Mannheim (DE); Markus Haberer, Osnabruck (DE); Helmut Hartl, Braunschweig (DE)

Correspondence Address: CONNOLLY BOVE LODGE & HUTZ, LLP, P O BOX 2207, WILMINGTON, DE, 19899, US

(73) Assignee: Basf Aktiengessellschaft, Ludwigshafen (DE)

(21) Appl. No.: 11/915,912

(22) PCT Filed: May 19, 2006
(86) PCT No.: PCT/EP06/62467

§ 371 Date: May 19, 2008

(30) Foreign Application Priority Data
May 30, 2005 (DE) 102005025017.3

(51) Int. Cl. C08L 53/00; C08F 210/10

(52) U.S. Cl. 525/89; 525/93; 525/94; 526/348.7

(57) ABSTRACT

Production of polymer blends using amphiphilic block copolymers which comprise poly-isobutene blocks and also polyoxyalkylene blocks, as compatibilizers.

The present invention relates to the production of polymer blends using amphiphilic block copolymers which comprise polyisobutene blocks and also polyoxyalkylene blocks as compatibilizers.

Mixtures of two or more polymers or copolymers (polymer blends) are used in order to tailor the profile of properties of polymers by increasing, for example, the impact strength, softness, density or hydrophilicity of a polymer. In order to achieve the desired tailoring of the polymer properties it is necessary frequently to combine different polymers which are not miscible with one another.

Polymer blends can be produced by melting or at least softening polymers with heating and intense mixing in suitable mixing apparatus, such as in an extruder. The miscibility can be improved here by means of polymeric compatibilizers, in some cases, indeed, blends only form in the presence of a suitable compatibilizer. A review of different compatibilizers is given by N. G. Gaylord, J. Macromol. Sci.—Chem., 1989, A26 (8), 1211-1229.

In the context of the recycling of polymers it is frequently impossible to separate the different grades of polymer, or at least to separate them completely, and so mixtures of polymers are produced almost inevitably. The large amounts of recyclate comprising polyethylene and polypropylene, in particular, which owing to their small density difference are almost impossible to separate using the standard industrial methods, are difficult to process, since the two polymers are substantially incompatible with one another (see, for example, P. Rajalingam and W. E. Baker, Proceedings ANTEC 1992, pp. 799-804).

EP-A 0 527 390 discloses the use of block copolymers or graft copolymers of styrene and dienes, preferably butadiene or isoprene, as compatibilizers in blends of polystyrene and polyolefins. The compatibilizer is used in an amount of 2% to 25%, preferably 5% to 20%, by weight.

In the case of polymers containing functional groups it is also possible to use what are called “reactive compatibilizers”. These compatibilizers have functional groups which are able to react with the functional groups of the polymer to be blended. J. Piglowski et al. (Angew. Makromol. Chem., 1999, 269, 61-70) disclose maleic anhydride-functionalized ethylene-vinyl acetate and ethylene-ethyl acrylate copolymers for blending polyamide with polypropylene. These compatibilizers react in the course of extrusion with the amino end groups of the polyamide.

Blends of polyethylene and polypropylene are known in principle. U.S. Pat. No. 4,632,861 discloses a blend of 65% to 95% by weight polyethylene with a density of 0.90 to 0.92 g/cm³, a melting temperature of less than 107° C., and a melt flow index of at least 25 with 5 to 35% by weight polypropylene with a melt flow index of at least 4 and a polydispersity M_{w}/Mₙ of at least 4. U.S. Pat. No. 6,407,171 discloses a blend of polyethylene having a melting point of at least 75° C., a degree of crystallization of at least 10%, and a polydispersity M_{w}/Mₙ of not more than 4 and polypropylene having a melt flow index of at least 500 g/min at 230° C. and a melting temperature of at least 125° C. The blend preferably comprises 90% to 99.9% by weight polyethylene. The polyethylene is prepared by means of metallocene catalysis. In the case of both blends, no compatibilizer is used in the preparation. Disadvantageously, however, only specific polyethylenes and polypropylenes, respectively, can be used. Moreover, the polymers obtainable are primarily polyethylene-rich polymers.

U.S. Pat. No. 5,804,286 discloses blends of polyethylene and polypropylene and their use for producing nonwovens, The polyethylene used is LLDPE having a density of about 0.92 to 0.93. As compatibilizers the use is proposed of propylene copolymers and terpolymers.

Kim et al. (J. Appl. Polym. Sci., 1993, 48, 1271) disclose blends of 80% polypropylene, 10% polyethylene, and 10% ethylene-propylene and/or ethylene-propylene-diene rubbers as compatibilizers. Plawky et al. (Macromolecular Symposia, 1996, 102, 183) disclose blends of isotactic polypropylene and LLDPE in a 4:1 ratio and 5% to 20% by weight of SEBS rubber as compatibilizer. P. Rajalingam et al. (Proceedings ANTEC 1992, pp. 799-804) achieved an increase in toughness in recyclate blends of 65% by weight PE and 35% by weight PP by adding a styrene-ethylene/butylene-styrene triblock copolymer. In the cited texts the compatibilizer is used in comparatively high amounts in each case.

WO 86/00081 discloses block copolymers prepared by reacting C₈ to C₃₀ alkenylsuccinic anhydride with at least one water-soluble straight-chain or branched polyalkylene glycol. The reaction products are used as thickeners for aqueous liquids.

WO 02/94889 discloses diblock copolymers preparable by reacting a succinic anhydride, substituted by a polyisobutylene group, with polar reactants such as polyalkylene glycols, for example. Additionally described is the use of the products as emulsifiers for water-in-oil emulsions, as additives in motor fuels and lubricants, or as dispersing assistants in dispersions of solids.

WO 04/35635 discloses the block copolymers which are preparable by reacting a succinic anhydride substituted by a polyisobutylene group, with polar reactants such as polyalkylene glycols, for example, and also the use of these block copolymers as auxiliaries for coloring hydrophobic polymers.

Our earlier application DE 102004007501.8, as yet unpublished, discloses aqueous polymer dispersions which are stabilized by means of di-, tri- or multiblock copolymers composed of polyisobutene units and also polyoxyalkylene units.

None of the four texts cited, however, discloses the use of block copolymers of this kind with hydrophilic blocks as compatibilizers for producing polymer blends.

It was an object of the invention to provide compatibilizers for producing polymer blends, which even in small amounts lead to rapid and effective mixing of the polymers used, and which can be used very universally. They ought in particular to be suitable for producing polypropylene/polyethylene blends.

Surprisingly it has been found that this objective can be achieved by means of the use of amphiphilic block copolymers.

In a first aspect of the invention the use has been found of block copolymers as compatibilizers for producing blends of at least two different polymers, the block copolymers comprising
at least one hydrophobic block (A) composed substantially of isobutene units and
at least one hydrophilic block (B) composed substantially of oxalkylene units.

In a second aspect of the invention, processes have been found for producing polymer blends by intensely mixing at least two different polymers with one another in the presence of said block copolymer and with heating.

In a third aspect of the invention, polymer blends have been found comprising at least two different polymers and also said block copolymers. In one preferred embodiment of the invention the blends in question are blends of polypropylene and other polymers.

### DETAILS OF THE INVENTION NOW FOLLOW

The amphiphilic block copolymers used in accordance with the invention as compatibilizers for producing blends comprise at least one hydrophobic block (A) and also at least one hydrophilic block (B). The blocks (A) and (B) are joined to one another by means of suitable linking groups. The blocks (A) and (B) may each be linear or else contain branches.

Block copolymers of this kind are known and can be prepared starting from methods and starting compounds that are known in principle to the skilled worker.

The hydrophobic blocks (A) are composed substantially of isobutene units. They are obtainable by polymerizing isobutene. The blocks may, however, also include, to a small extent, other comonomers as units. Units of this kind may be used in order to fine-tune the properties of the block. Comonomers for mention, besides 1-butene and cis- and/or trans-2-butene, include, in particular, isoolefins having 5 to 10 carbon atoms such as 2-methyl-1-bute-1-ene, 2-methyl-1-pentene, 2-methyl-1-hexene, 2-ethyl-1-pentene, 2-ethyl-1-hexene, and 2-propyl-1-heptene, or vinylaromatics such as styrene and α-methylstyrene, C₁-C₄ alkylstyrenes such as 2-, 3- and 4-methylstyrene and 4-tert-butylstyrene. The fraction of such comonomers ought not, however, to be too great. As a general rule their amounts should not exceed 20% by weight, based on the amount of all units in the block. Besides the isobutene units and comonomers the blocks may also comprise the starter molecules used at the start of the polymerization, or fragments thereof. The polyisobutenes thus prepared may be linear, branched or star-shaped. They may contain functional groups only at one chain end or else at two or more chain ends.

Starting material for the hydrophobic blocks A are functionalized polyisobutenes. Functionalized polyisobutenes can be prepared starting from reactive polyisobutenes by providing them with functional groups in single-stage or multistage reactions known in principle to the skilled worker. By reactive polyisobutene the skilled worker understands polyisobutene which has a very high fraction of terminal α-olefin end groups. The preparation of reactive polyisobutenes is likewise known and described, for example, in detail in the already cited texts WO 04/9654, pages 4 to 8, or in WO 04/35635, pages 6 to 10.

### PREFERRED EMBODIMENTS OF THE FUNCTIONALIZATION OF REACTIVE POLYISOBUTENE COMPRISE

i) reacting aromatic hydroxy compounds in the presence of an alkylating catalyst to give aromatic hydroxy compounds alkylated with polyisobutenes,
ii) reacting the polyisobutene block with a peroxy compound to give an epoxidized polyisobutene,
iii) reacting the polyisobutene block with an alkene containing a double bond substituted by electron-withdrawing groups (enophile), in an ene reaction,
iv) reacting the polyisobutene block with carbon monoxide and hydrogen in the presence of a hydroformylation catalyst to give a hydroformylated polyisobutene,
v) reacting the polyisobutene block with a phosphorus halide or a phosphorus oxychloride to give a polyisobutene functionalized with phosphonic groups,
vi) reacting the polyisobutene block with a borane, followed by oxidative cleavage, to give a hydroxylated polyisobutene,
vii) reacting the polyisobutene block with an SO₃ source, preferably acetyl sulfate or oleum, to give a polyisobutene containing terminal sulfonic acid groups,
viii) reacting the polyisobutene block with oxides of nitrogen, followed by hydrogenation, to give a polyisobutene containing terminal amino groups.

For all details for implementing the stated reactions we refer to the statements in WO 04/35635, pages 11 to 27.

Particular preference is given to embodiment iii). With very particular preference maleic anhydride is used for the reaction in that case. This results in polyisobutenes functionalized with succinic anhydride groups (polyisobutenylsuccinic anhydride, PIBSA).

The molar mass of the hydrophobic blocks A is set by the skilled worker in accordance with the desired application. In general the hydrophobic blocks (A) each have an average molar mass Mₙ of 200 to 10 000 g/mol. Mₙ is preferably 300 to 8000 g/mol, more preferably 400 to 6000 g/mol, and very preferably 500 to 5000 g/mol.

The hydrophilic blocks (B) are composed substantially of oxalkylene units. Oxalkylene units are, in a way which is known in principle, units of the general formula —R¹—O—. In this formula R¹ is a divalent aliphatic hydrocarbon radical which may also, optionally, have further substituents. Additional substituents on the radical R¹ may comprise, in particular, O-containing groups, examples being >C═O groups or OH groups. A hydrophilic block may of course also comprise two or more different oxyalkylene units.

The oxalkylene units may in particular be —(CH₂)₂—O—, —(CH₂)₃—O—, —(CH₂)₄—O—, —CH₂—CH(R²)—O—, —CH₂—CHOR³—CH₂—O—, with R² being an alkyl group, especially C₁-C₂₄ alkyl, or an aryl group, especially phenyl, and R³ being a group selected from the group consisting of hydrogen, C₁-C₂₄ alkyl, R¹—C(═O)—, and R¹—NH—C(═O)—.

The hydrophilic blocks may also comprise further structural units, such as ester groups carbonate groups or amino groups, for example. They may additionally comprise the starter molecules used at the start of the polymerization, or fragments thereof. Examples comprise terminal groups R²—O—, where R² is as defined above.

As a general rule the hydrophilic blocks comprise ethylene oxide units —(CH₂)₂—O— and/or propylene oxide units —CH₂—CH(CH₃)—O, as main components, while higher alkylene oxide units, i.e. those having more than 3 carbon atoms, are present only in small amounts in order to fine-tune the properties. The blocks may be random copolymers, gradient copolymers, alternating or block copolymers comprising ethylene oxide and propylene oxide units. The amount of higher alkylene oxide units ought not to exceed 10% by weight, preferably 5% by weight. The blocks in question are preferably blocks comprising at least 50% by weight of ethylene oxide units, preferably 75% by weight, and more preferably at least 90% by weight of ethylene oxide units. With very particular preference the blocks in question are pure polyoxyethylene blocks.

The hydrophilic blocks B are obtainable in a manner known in principle, for example, by polymerizing alkylene oxides and/or cyclic ethers having at least 3 carbon atoms and also, optionally, further components. They may additionally be prepared by polycondensing dialcohols and/or polyalcohols, suitable starters, and also, optionally, further monomeric components.

Examples of suitable alkylene oxides as monomers for the hydrophilic blocks B comprise ethylene oxide and propylene oxide and also 1-butene oxide, 2,3-butene oxide, 2-methyl-1,2-propene oxide (isobutene oxide), 1-pentene oxide, 2,3-pentene oxide, 2-methyl-1,2-butene-oxide, 3-methyl-1,2-butene oxide, 2,3-hexene oxide, 3,4-hexene oxide, 2-methyl-1,2-pentene oxide, 2-ethyl-1,2-butene oxide, 3-methyl-1,2-pentene oxide, decene oxide, 4-methyl-1,2-pentene oxide, styrene oxide, or be formed from a mixture of oxides of industrially available raffinate streams. Examples of cyclic ethers comprise tetrahydrofuran. It is of course also possible to use mixtures of different alkylene oxides. The skilled worker makes an appropriate selection from among the monomers and further components in accordance with the desired properties of the block.

The hydrophilic blocks B may also be branched or star-shaped. Blocks of this kind are obtainable by using starter molecules having at least 3 arms. Examples of suitable starters comprise glycerol, trimethylolpropane, pentaerythritol or ethylenediamine.

The synthesis of alkylene oxide units is known to the skilled worker. Details are given at length, for example, in “Polyoxyalkylenes” in Ullmann's Encyclopedia of Industrial Chemistry, 6^{th} Edition, Electronic Release.

The molar mass of the hydrophilic blocks B is set by the skilled worker in accordance with the desired application. In general the hydrophilic blocks (B) each have an average molar mass Mₙ of 500 to 20 000 g/mol. Mₙ is preferably 1000 to 18 000 g/mol, more preferably 1500 to 15 000 g/mol, and very preferably 2500 to 8000 g/mol.

The synthesis of the block copolymers used in accordance with the invention can be performed preferably by first separately preparing the hydrophilic blocks B and reacting them in a polymer-analogous reaction with the functionalized polyisobutenes to form block copolymers.

The units for the hydrophilic and hydrophobic blocks have complementary functional groups, i.e., groups which are able to react with one another to form linking groups.

The functional groups of the hydrophilic blocks are of course preferably OH groups, but may also be primary or secondary amino groups, for example. OH groups are particularly suitable as complementary groups for the reaction with PIBSA.

In another embodiment of the invention the synthesis of the blocks B can also be performed by reacting polyisobutenes containing polar functional groups (i.e., blocks A) directly with alkylene oxides to form blocks B.

The structure of the block copolymers used in accordance with the invention can be influenced by selecting identity and amount of the starting materials for the blocks A and B and also the reaction conditions, particularly the sequence of the addition.

The blocks A and/or B can be arranged terminally, i.e., can be joined only to one other block, or else they can be joined to two or more other blocks. The blocks A and B may be linked to one another, for example, linearly in alternate arrangement with one another. In principle it is possible to use any desired number of blocks. As a general rule, however, there are not more than 8 blocks A and 8 blocks B present in each case. This results in the simplest case in a diblock copolymer of the general formula AB. The block copolymers may also be triblock copolymers of the general formula ABA or BAB. It is of course also possible for two or more blocks to follow one another: for example, ABAB, BABA, ABABA, BABAB or ABABAB.

The block copolymers may also be star-shaped and/or branched block copolymers or else comblike block copolymers, in which in each case more than two blocks A are attached to one block B or more than two blocks B to one block A. By way of example they may be block copolymers of the general formula ABₘ or BAₘ where m is a natural number ≧3, preferably 3 to 6 and more preferably 3 or 4. It will be appreciated that in the arms and/or branches there may also be two or more blocks A and B in succession, A(BA)ₘ or B(AB)ₘ for example.

The synthesis possibilities are depicted below by way of example for OH groups and succinic anhydride groups (denoted S), without any intention that the invention should thereby be restricted to the use of functional groups of these kinds.

| | |
|---|---|
| HO-[B]-OH | Hydrophilic blocks containing two OH groups |
| [B]-OH | Hydrophilic blocks containing only one OH group |
| [B]-(OH)ₓ | Hydrophilic blocks containing x OH groups (x ≧ 3) |
| [A]-S | Polyisobutene with a terminal group S |
| S-[A]-S | Polyisobutene with two terminal groups S |
| [A]-S_{y} | Polyisobutene with y groups S (y ≧ 3) |

The OH groups can be linked in a manner known in principle to the succinic anhydride groups S to form ester groups with one another. The reaction can be accomplished, for example, by heating without solvent. Examples of suitable reaction temperatures are temperatures from 80 to 150° C.

Triblock copolymers A-B-A are formed, for example, in a simple way by reacting one equivalent of HO-[B]-OH with two equivalents of [A]-S. This is depicted below by way of example with complete formulae. The example used is the reaction of PIBSA and a polyethylene glycol:

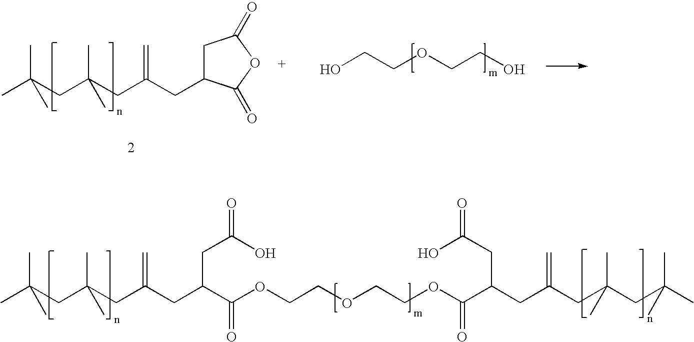

In these formulae n and m independently of one another are natural numbers. They are selected by the skilled worker so as to give the molar masses defined at the outset for the hydrophobic blocks and the hydrophilic blocks respectively.

Star-shaped or branched block copolymers BA, can be obtained by reacting [B]-(OH)ₓ with x equivalents of [A]-S.

For the skilled worker in the field of polyisobutenes it is clear that, depending on the preparation conditions, the block copolymers obtained may also contain residues of starting materials. They may also be mixtures of different products. Triblock copolymers of formula ABA may, for example, additionally comprise diblock copolymers AB and also functionalized and unfunctionalized polyisobutene. With advantage these products can be used without further purification for the application. It is of course also possible, however, to purify the products as well. Methods of purification are known to the skilled worker.

The block copolymers described are used in accordance with the invention for producing blends of at least two different polymers. They can be used, for example, to produce blends from the following polymers:

PP/PE, PP/PA, PE/PA, PE/PIB, PP/other polyolefins,

### PP/polyester,

### PVC/polyolefin,

ABS/PA, ABS/PPO, ABS/TPU, ABS/EPDM, ABS/SMA (styrene-maleic anhydride),

### PA/PC,

PC/ABS (with increased acrylonitrile fraction), PC/SAN, PC/polyester, PC/PMMA,

### PC/polyetherimide,

PVDF (polyvinylidene fluoride)/polyolefin, PVDF/PMMA,
PPE (polyphenylene ether)/PS, PPE/PA, PPE/polyolefin.

They are additionally suitable especially for reprocessing of recycled polyethylene (HDPE, LDPE, LLDPE) and/or polypropylene. Products of this kind are generally not single grades but instead constitute mixtures of polyethylene and polypropylene. With inventive use of the block copolymers described it is also possible to produce, from these mixtures, high-quality blends, whereas without them the products obtained are generally only of low quality.

The block copolymers described can additionally be used for producing what are called bimodal blends, where the intention is to blend with one another polymers which, although composed substantially of the same monomers, have significantly different molecular weights. Reference may be made by way of example to blends of extremely high molecular weight polyethylene and polyethylene of low molecular weight.

To produce the blends the skilled worker selects suitable block copolymer compatibilizers in accordance with the nature of the polymers employed. It is self-evident to the skilled worker that one single type of compatibilizer will not be equally suitable for all types of polymer blends. It is a very particular advantage of the block copolymers used in accordance with the invention that, starting from a few basic components it is possible, following a modular principle, so to speak, to put together compatibilizers appropriate for the particular application. It is of course also possible to use mixtures of different compatibilizers.

As well as the arrangement of the blocks it is also possible to adapt, for example, the length of the blocks A and/or B, i.e., their molar mass, specifically for a particular use. By way of the composition of the hydrophilic blocks B it is possible to adjust the degree of hydrophilicity of the B blocks. The degree of hydrophilicity can be adjusted easily, for example, through the ratio of ethylene oxide units to propylene oxide units and/or higher alkylene oxides.

It is possible with preference to use triblock copolymers of the ABA type, diblock copolymers AB, and also star-shaped block copolymers having terminal hydrophobic blocks A, such as BA₃ or BA₄ copolymers, for example. In addition it is possible to use mixtures of diblock copolymers with triblock copolymers.

Advantageously it is also possible to use impure, industrial products. For example, by reacting 2 equivalents of functionalized polyisobutene with one equivalent of a polyoxyalkylene it is possible to obtain a mixture which comprises triblock copolymers ABA but also, in addition, diblock copolymers plus starting material. The respective amounts can be influenced through the choice of the reaction conditions.

The amount of compatibilizer used is selected by the skilled worker in accordance with the desired blend. Irrespective of the polymers employed, a certain minimum amount is necessary in order to achieve the effective blending desired. In the case of the compatibilizers used in accordance with the invention it is possible for just 0.05% by weight, based on the total amount of all components of the blend, to be sufficient. Excessive fractions ought to be avoided, so that the compatibilizer does not adversely affect the properties of the blend. As a general rule, amounts of 0.05% to 10% by weight with respect to the total amount of all components of the blend have been found appropriate. The amount is preferably 0.2% to 5%, more preferably 0.3% to 3%, very preferably 0.4% to 2%, and, for example, approximately 0.5% by weight.

The compatibilizers used in accordance with the invention are preferably used as single compatibilizers, although it is of course also possible to use the compatibilizers in a mixture with further compatibilizers other than the block copolymers described.

The production of the blends can take place in a way which is known in principle, by heating and intense mixing of the polymers and the compatibilizer, using suitable apparatus. By way of example it is possible to employ compounders, single-screw extruders, twin-screw extruders or other dispersing assemblies. The discharge of the polymer blend in liquid melt form from the mixing assemblies can take place in a manner known in principle via dies. By this means it is possible, for example, to shape strands and to chop them to pellets. Alternatively, the composition in liquid melt form can be shaped directly to moldings, by means of injection molding or blow molding, for example.

The compatibilizer or mixture of different compatibilizers may preferably be added without solvent to the polymers, but can also be added in solution.

In one preferred embodiment of the process it is also possible to mix at least one compatibilizer first with a fraction of the polymers employed, with heating, and in a second step to mix the resulting concentrate of polymer and compatibilizer with the remainder of the polymers, again with heating. A typical concentrate may comprise 5% to 50%, preferably 10% to 30%, by weight of the compatibilizer.

The temperature for blending is selected by the skilled worker and is guided by the nature of the polymers used. The polymers ought on the one hand to soften sufficiently that commixing is possible. On the other hand they ought not to become too runny, since otherwise it is impossible to put in sufficient shear energy, and in some cases there may even be a risk of thermal degradation. As a general rule it is possible to employ temperatures of 120 to 300° C., without any intention that the invention should be restricted thereto. It is found particularly advantageous in this context that the block copolymers used in accordance with the invention exhibit a high thermal stability.

Besides the polymers and the compatibilizers the blends may of course also comprise typical auxiliaries and/or additives. Examples comprise colorants, antistats, biocides, UV absorbers, stabilizers or fillers.

The compatibilizers used in accordance with the invention allow a homogeneous blend to be obtained substantially more rapidly. It is also possible to lower the input of shear energy without losses in terms of quality. Thus, for example, single-screw extruders are generally sufficient for producing the blends of the invention. There is generally no need for twin-screw extruders, although this is not intended to rule out their use.

The block copolymers are particularly suitable, in accordance with the invention, for producing blends wherein at least one of the polymers is a polyolefin, preferably blends of different polyolefins. The polyolefins may also be copolymers of different olefins.

In one particularly preferred embodiment of the invention the blends in question are blends comprising polyethylene and polypropylene, particularly blends of polyethylene and polypropylene.

The terms “polyethylene” and “polypropylene” may stand in this case for ethylene and propylene homopolymers, respectively. However, the terms of course also comprise polymers which are composed substantially of ethylene or propylene, respectively, and which additionally comprise, in small amounts, other monomers, especially other olefins, for fine-tuning of the properties.

The polyethylene may be, for example, LDPE, HDPE or LLDPE. The compatibilizers used in accordance with the invention are also particularly suitable for producing blends of polypropylene and HDPE.

The selection of polypropylene is not limited. The products in question may be high-density products and low-density products, With particular advantage it is also possible to process viscous polypropylenes having a high melt flow index. The polypropylene in question, for example, may have a melt flow index MFR (230° C., 2.16 kg) of less than 40 g/10 min.

The PE and PP used may in each case be virgin products or else recycled material.

Particularly advantageous for the blending of polypropylene and polyethylene are triblock copolymers ABA composed of PIBSA and polyethylene glycols, in which the average molar mass Mₙ of the two A blocks is 350 to 3000 g/mol and that of the middle B block is 1500 to 15 000 g/mol, preferably 4000 to 12 000 g/mol. In the case of this application the compatibilizer is used generally in an amount of 0.1% to 2% by weight, preferably 0.15% to 1.5% by weight, and more preferably 0.3% to 1.2% by weight, based in each case on the amount of all components in the blend.

Polyethylene and polypropylene can be blended with one another in arbitrary ratios. With preference, however, it is possible to blend mixtures comprising at least 50% by weight polypropylene. Table 1 comprises a compilation of preferred compositions.

TABLE 1
Composition of preferred PE/PP blends (all figures in % by weight)

| | | particularly | very particularly |
|---|---|---|---|
| | preferred | preferred | preferred |
| PP | 50.0-99.0 | 70.0-97.0 | 85.0-95.0 |
| PE | 0.9-49.9 | 2.9-29.9 | 14.9-9.9 |
| Block copolymer | 0.1-2 | 0.1-2 | 0.1-2 |

As a result of the blending of PE it is possible to obtain a material which is much softer than pure PP. The PP/PE blend can be used, for example, for fiber blends, multilayer films, and moldings.

With particular advantage the compatibilizers used in accordance with the invention can be used for producing blends of recycled polyethylene and recycled polypropylene. In this case it is possible to obtain blends having good technical properties from recycled mixtures of polyethylene and polypropylene.

In a further, particularly preferred embodiment of the invention the blends in question are blends of polyolefins and polyesters, especially blends of polypropylene and polyesters. The polyesters are, in particular, PET.

Polypropylene and polyester can be blended with one another in any desired proportions. With preference, however, it is possible to blend mixtures comprising at least 50% by weight polypropylene. In the case of this application the compatibilizer is used in general in an amount of 0.1% to 2% by weight, preferably 0.15% to 1.5% by weight, and more preferably 0.2% to 1% by weight, based in each case on the amount of all components in the blend. Higher amounts of the compatibilizers used in accordance with the invention do not in general provide any further improvement in miscibility, but may impair the mechanical properties.

The examples which follow are intended to illustrate the invention:

### A) Preparation of the Compatibilizers Used

### Compatibilizer 1:

Preparation of a Compatibilizer with ABA Structure from PIBSA 550 and Polyethylene Glycol 1500

Reaction of PIBSA₅₅₀ (molar mass Mₙ 550, hydrolysis number HN=162 mg/g KOH) with Pluriol® E1500 (polyethylene oxide, Mₙ≈1500)

A 4-I three-neck flask with internal thermometer, reflux condenser and nitrogen tap was charged with 693 g of PIBSA (Mₙ=684; dispersity index DP=1.7) and 750 g of Pluriol® E1500 (Mₙ≈1500, DP=1.1). In the course of heating to 80° C., the batch was evacuated 3× and blanketed with N₂. The reaction mixture was heated to 130° C. and held at this temperature for 3 h. Thereafter the product was cooled to room temperature. The following spectra were recorded:

IR-spectrum (KBr) in cm⁻¹:

OH stretching at 3308; C—H stretching at 2953, 2893, 2746; C═O stretching at 1735; C═C stretching at 1639; further vibrations of the PIB skeleton: 1471, 1390, 1366, 1233; ether vibration of the Pluriol at 1111.

1-H-NMR-spectrum (CDCl₃, 500 MHz, TMS, room temperature) in ppm:

4.9-4.7 (C═C of PIBSA); 4.3-4.1 (C(O)—O—CH₂—CH₂—); 3.8-35 (O—CH₂—CH₂—O, PEO chain); 3.4 (O—CH₃); 3.1-2.9; 2.8-2.4; 2.3-2.1; 2.1-0.8 (methylene and methine of the PIB chain)

Compatibilizer 2:

Preparation of the Compatibilizer with ABA Structure from PIBSA 550 and Polyethylene Glycol 9000

Reaction of PIBSA₅₅₀ (hydrolysis number HN=162 mg/g KOH) with Pluriol® E9000 (polyethylene oxide, Mₙ≈9000)

A 4-I three-neck flask with internal thermometer, reflux condenser and nitrogen tap was charged with 346 g of PIBSA (Mₙ=684; DP=1.7) and 2250 g of Pluriol® E9000 (Mₙ≈9000, DP=1.2). In the course of heating to 80° C., the batch was evacuated 3× and blanketed with N₂. The reaction mixture was then heated to 130° C. and held at this temperature for 3 h. Thereafter the product was cooled to room temperature and investigated spectroscopically:

IR-spectrum (KBr) in cm⁻¹:

OH stretching at 3310; C—H stretching at 2951, 2891, 2742; C═O stretching at 1734; C═C stretching at 1639; further vibrations of the PIB skeleton: 1471, 1389, 1365, 1235; ether vibration of the Pluriol at 1110.

1-H-NMR-spectrum (CDCl₃, 500 MHz, TMS, room temperature) in ppm:

comparable with Example 1, different intensities: 4.9-4.7 (C═C of PIBSA); 4.3-4.1 (C(O)—O—CH₂—CH₂—); 3.8-3.5 (O—CH₂—CH₂—O, PEO chain); 3.4 (O—CH₃); 3.1-2.9; 2.8-2.4; 2.3-2.1; 2.1-0.8 (methylene and methine of the PIB chain)

### Compatibilizer 3:

Preparation of a compatibilizer with ABA structure from PIBSA 1000 and polyethylene glycol 1500

Reaction of PIBSA₁₀₀₀ (hydrolysis number HN=86 mg/g KOH) with Pluriol® E1500 (polyethylene oxide, Mₙ=1500)

A 4-1 three-neck flask with internal thermometer, reflux condenser and nitrogen tap was charged with 1305 g of PIBSA (Mₙ=1305; DP=1.5) and 750 g of Pluriol® E1500 (M, 1500, DP=1.1). In the course of heating to 80° C., the batch was evacuated 3× and blanketed with N₂. The reaction mixture was then heated to 130° C. and held at this temperature for 3 h. Thereafter the product was cooled to room temperature and investigated spectroscopically.

IR-spectrum (KBr) in cm⁻¹:

OH stretching at 3311; C—H stretching at 2957, 2891, 2744; C═O stretching at 1730; C═C stretching at 1642; further vibrations of the PIB skeleton: 1470, 1387, 1365, 1233; ether vibration of the Pluriol at 1106.

1-H-NMR-spectrum (CDCl₃, 500 MHz, TMS, room temperature) in ppm:

comparable with Example 1, different intensities: 4.9-4.7 (C═C of PIBSA); 4.3-4.1 (C(O)—O—CH₂—CH₂—); 3.8-3.5 (O—CH₂—CH₂—O, PEO chain); 3.4 (O—OCH₃); 3,1-2.9; 2.8-2.4; 2.3-2.1; 2.1-0.8 (methylene and methine of the PIB chain)

### Compatibilizer 4:

Preparation of a compatibilizer with ABA structure from PIBSA 1000 and polyethylene glycol 6000 Reaction of PIBSA₁₀₀₀ (hydrolysis number HN=86 mg/g KOH) with Pluriol® E6000 (polyethylene oxide, Mₙ≈16000)

A 4-I three-neck flask with internal thermometer, reflux condenser and nitrogen tap was charged with 783 g of PIBSA (Mₙ=1305; DP=1.5) and 1800 g of Pluriol® E6000 (Mₙ≈6000, DP=1.1). In the course of heating to 80° C., the batch was evacuated 3× and blanketed with N₂. The reaction mixture was then heated to 130° C. and held at this temperature for 3 h. Thereafter the product was cooled to room temperature and investigated spectroscopically.

IR-spectrum (KBr) in cm⁻¹:

OH stretching at 3310; C—H stretching at 2956, 2890, 2745; C═O stretching at 1732; C═C stretching at 1640; further vibrations of the PIB skeleton: 1471, 1388, 1365, 1232; ether vibration of the Pluriol at 1109.

1-H-NMR-spectrum (CDCl₃, 500 MHz, TMS, room temperature) in ppm:

comparable with Example 1, different intensities: 4.9-4.7 (C═C of PIBSA); 4.3-4.1 (C(O)—O—CH₂—CH₂—); 3.8-3.5 (O—CH₂—CH₂—O, PEO chain); 3.4 (O—CH₃); 3,1-2.9; 2.8-2.4; 2.3-2.1; 2.1-0.8 (methylene and methine of the PIB chain)

### Compatibilizer 5:

Preparation of the Compatibilizer with ABA Structure from PIBSA 1000 and Polyethylene Glycol 12000

Reaction of PIBSA₁₀₀₀ (hydrolysis number HN=86 mg/g KOH) with Pluriol® E12000 (polyethylene oxide, Mₙ≈12 000) A 4-I three-neck flask with internal thermometer, reflux condenser and nitrogen tap was charged with 392 g of PIBSA (Mₙ=1305; DP=1.5) and 1800 g of Pluriol® E12000 (Mₙ≈12 000, DP=1.2). In the course of heating to 80° C., the batch was evacuated 3× and blanketed with N₂. The reaction mixture was then heated to 130° C. and held at this temperature for 3 h. Thereafter the product was cooled to room temperature and investigated spectroscopically.

IR-spectrum (KBr) in cm⁻¹:

OH stretching at 3309; C—H stretching at 2950, 2892, 2744; C═C stretching at 1738; C═C stretching at 1640; further vibrations of the PIB skeleton: 1471, 1388, 1366, 1234; ether vibration of the Pluriol at 1110.

1-H-NMR-spectrum (CDCl₃, 500 MHz, TMS, room temperature) in ppm:

comparable with Example 17 different intensities: 4.9-4.7 (C═C of PIBSA); 4.3-4.1 (C(O)—O—CH₂—CH₂—); 3.8-3.5 (O—CH₂—CH₂═O, PEO chain); 3.4 (O—CH₃); 3,1-2.9; 2.8-2.4; 2.3-2.1; 2.1-0.8 (methylene and methine of the PIB chain)

### B) Production of Blends

### Polymers Used

The experiments were carried out using the following polymers:

### Polymer 1:

Polypropylene homopolymer, narrow molecular weight distribution (Moplen® 561 S, Basell Polyolefine)

MFR (230° C., 2.16 kg) 25 g/10 min

### Polymer 2:

HD polyethylene (HDPE 5862 N; Dow Chemical)

MFR (230° C., 2.16 kg) 4.2-5.8 g/10 min

Density 0.960-0.965 g/cm³

Polymer 3:

Polyethylene terephthalate (G 6506, Kuag Oberbruch GmbH) with 0.5% by weight TiO₂, softening point 259° C.

### Producing a Concentrate (Masterbatch) of Polypropylene and Compatibilizer

First of all a concentrate was produced from compatibilizer 4 (triblock, PIBSA 1000 and PEG 6000) and polypropylene (polymer 1).

Apparatus: heated single-screw extruder

For this purpose the polypropylene granules were premixed with the compatibilizer in an amount of 10% by weight, relative to the sum of polymer and compatibilizer, and the mixture was intimately mixed in the screw at a jacket temperature of 170° C., and the hot mixture was discharged from the extruder through a die. It is also possible to choose jacket temperatures of 160 to 220° C. This produces an extrudate having a diameter of about 0.2 cm, which cools down as it passes through a water bath. The cooled extrudate was processed to granules (particle size approximately 0.2 cm×0.2 cm). These granules thus produced are obtained as an intermediate and are used again in the subsequent steps.

### Production of Blends of Polyethylene and Polypropylene

### Example 1

To produce a blend of the invention the abovementioned concentrate, polypropylene (polymer 1) and HD polyethylene (polymer 2) were metered individually into a spinning machine and introduced into a heatable zone. The polymer mixture was intimately mixed in a screw and discharged from the apparatus through a perforated plate. By means of air the filaments thus obtained are stretched and cooled, The amounts of polymers used are compiled in Table 2.

Subsequently the filaments are deposited irregularly on a conveyor belt and transported on. The webs of the polymer mixture that are produced in this way are consolidated by means of a calender with pressure at a temperature of 125° C. Thereafter the resulting web was rolled up and the properties of the textile structure were measured.

The quality of the blends was characterized by measuring the tensile elongation of the webs. The elongation is indicated in Table 2.

### Comparative Example 1

A mixture of polymer 1 and polymer 2 was used, as described, but no compatibilizer was employed. No blending took place; instead, two separate phases were discharged from the perforated plate. Filaments suitable for forming webs or fibers were unobtainable. The amounts and results are compiled in Table 2.

TABLE 2
Production of PP/PE blends, data and results for inventive and
comparative examples, amounts in each case in % by weight.

| | | | | | Tensile | |
|---|---|---|---|---|---|---|
| | Amount | Amount | Compatibilizer | | elongation | |
| Example | of PP | of PE | Type | Amount | [%] | Remarks |
| Inventive 1 | 95 | 4 | 4 | 1 | 95 | — |
| Inventive 2 | 93 | 6 | 4 | 1 | 115 | — |
| Comparative | 90 | 10 | none | — | — | No |
| 1 | | | | | | blending |
| Comparative | 100 | — | none | — | 20 | |
| 2 | | | | | | |

The inventive and comparative experiments show that even small amounts of the block copolymer used in accordance with the invention as compatibilizer lead to high-quality blends. As a result of blending polypropylene with even small amounts of polyethylene, the tensile elongation of the material is increased very significantly.

### Production of Blends of Polypropylene and Polyester

To produce the blends the abovementioned concentrate, polypropylene (polymer 1), and polyester (PET, polymer 3) were premixed then introduced in the single-screw extruder described above. The polymer mixture was intimately mixed in the screw, discharged from the extruder through a die, and processed as above. The jacket temperature in the case of these experiments was between 200° C. and 260° C. This gave an extrudate having a diameter of about 0.2 cm, which cooled down as it passed through a water bath. The cooled extrudate was processed to granules (particle size about 0.2 cm×0.2 cm). To measure the tensile elongation the granules were shaped to a dumbbell measurement specimen (measured by a method based on ISO 527-2: 1993). The amounts of the components in the blend and also the tensile elongation are indicated in Table 3.

Polypropylene/PET blends with 10%, 25%, and 50% by weight were produced. The amount of the compatibilizer was 0.4% in the case of the 10% blend and 1.0% in the case of the 25% blend. The blending of the two polymers was excellent in each case and gave blends of outstanding quality.

In a further series of experiments the concentration of the compatibilizer was varied for the 50:50 blend.

TABLE 3
Properties of polypropylene/PET blends. Amounts in each case in % by
weight.

| | | Amount of | Tensile elongation |
|---|---|---|---|
| Amount of PP | Amount of PET | compatibilizer | (in %) |
| 49.75 | 49.75 | 0.5 | 160 |
| 49.5 | 49.5 | 1.0 | 60 |
| 49 | 49 | 2.0 | 40 |

The results show that in the case of PP/PET blends even small amounts of the compatibilizer lead to products with good tensile elongation. Larger amounts are in fact deleterious with regard to the tensile elongation.

A further blend of 90% PP and 10% PET with 0.5% compatibilizer was additionally spun through a fine die, stretched, and knitted on a knitting machine to give a textile fabric, with no tearing of filaments.

1-21. (canceled)

22. A process for producing a polymer blend by intensely mixing at least two different polymers with one another in the presence of one or more block copolymer compatibilizers while heating, wherein said block copolymers comprise
(a) at least one hydrophobic block (A) substantially comprising isobutene units; and
(b) at least one hydrophilic block (B) substantially comprising oxalkylene units;
wherein said block copolymers are present is an amount of from 0.05% to 10% by weight, based on the total weight of all components of the blend.

23. The process of claim 22, wherein the average molar mass Mₙ of said at least one hydrophobic block (A) is from 200 to 10,000 g/mol and the average molar mass Mₙ of said at least one hydrophilic block (B) is from 500 to 20,000 g/mol.

24. The process of claim 22, wherein said at least one hydrophilic block comprises at least 50% by weight of ethylene oxide units.

25. The process of claim 22, wherein said compatibilizer is at least one triblock copolymer of general formula A-B-A.

26. The process of claim 22, wherein said compatibilizer is at least one diblock copolymer of general formula A-B.

27. The process of claim 22, wherein said compatibilizer is a mixture of at least one triblock copolymer of general formula A-B-A and at least one diblock copolymer of general formula A-B.

28. The process of claim 22, wherein said block copolymer is used in an amount of from 0.2% to 3% by weight.

29. The process of claim 22, wherein said polymer blend is selected from the group consisting of PP/PE, PP/PA, PE/PA, PE/PIB, PP/other polyolefins, PP/polyester, PVC/polyolefin, ABS/PA, ABS/PPO, ABS/TPU, ABS/EPDM, ABS/SMA, PA/PC, PC/ABS, PC/SAN, PC/polyester, PC/PMMA, PC/polyetherimide, PVDF/polyolefin, PVDF/PMMA, PPE/PS, PPE/PA, and PPE/polyolefin.

30. The process of claim 22, wherein at least one of the polymers used is a polyolefin.

31. The process of claim 22, wherein the polymers used to produce the blend are polypropylene and polyethylene or polypropylene and a polyester.

32. The process of claim 31, wherein said polypropylene has a melt flow under MFR (230° C., 2.16 kg) of less than 40 g/10 min.

33. The process of claim 22, wherein said compatibilizer is first mixed with a portion of the polymers used while heating to form a concentrate of polymer and compatibilizer, followed by mixing the resulting concentrate with the remainder of the polymers while heating.

34. The process of claim 22, wherein said heating is carried out at a temperature of from 120° C. to 300° C.

35. A polymer blend comprising at least two different polymers and one or more block copolymer compatibilizers, wherein said one or more block copolymer compatibilizers comprise
(a) at least one hydrophobic block (A) substantially comprising isobutene units; and
(b) at least one hydrophilic block (B) substantially comprising oxalkylene units, wherein said block copolymers are present is an amount of from 0.05% to 10% by weight, based on the total weight of all components of the blend.

36. The polymer blend of claim 35, wherein said one or more block copolymer compatibilizers is present in an amount of from 0.2% to 3% by weight.

37. The polymer blend of claim 35, wherein said polymer blend is selected from the group consisting of PP/PE, PP/PA, PE/PA, PE/PIB, PP/other polyolefins, PP/polyester, PVC/polyolefin, ABS/PA, ABS/PPO, ABS/TPU, ABS/EPDM, ABS/SMA, PA/PC, PC/ABS, PC/SAN, PC/polyester, PC/PMMA, PC/polyetherimide, PVDF/polyolefin, PVDF/PMMA, PPE/PS, PPE/PA, and PPE/polyolefin.

38. The polymer blend of claim 35, wherein said polymer blend comprises polyolefin.

39. The polymer blend of claim 35, wherein said polymer blend comprises polypropylene and polyethylene or polypropylene and a polyester.

40. The polymer blend of claim 39, wherein said polypropylene is present in an amount of at least 75% by weight.

41. The polymer blend of claim 39, wherein said polypropylene has a melt flow under MFR (230° C., 2.16 kg) of less than 40 g/10 min.

42. A compatibilizer for producing a blend of at least two different polymers comprising a block copolymer which comprises
(a) at least one hydrophobic block (A) substantially comprising isobutene units; and
(b) at least one hydrophilic block (B) substantially comprising oxalkylene units.
